(19) United States
(12) Patent Application Publication
(10) Pub. No.: US 2023/0378842 A1
(43) Pub. Date: Nov. 23, 2023

(54) MOTOR

(71) Applicant: LG INNOTEK CO., LTD., Seoul (KR)

(72) Inventors: Hyun Soo YU, Seoul (KR); Min Oak KIM, Seoul (KR); Hee Soo LIM, Seoul (KR); Jung Ho HAN, Seoul (KR)

(73) Assignee: LG INNOTEK CO., LTD., Seoul (KR)

(21) Appl. No.: 18/027,540

(22) PCT Filed: Sep. 17, 2021
(86) PCT No.: PCT/KR2021/012775

§ 371 Date: Mar. 21, 2023

(30) Foreign Application Priority Data
Sep. 21, 2020 (KR) 10-2020-0121390
Nov. 24, 2020 (KR) 10-2020-0158821
Dec. 10, 2020 (KR) 10-2020-0172104

(51) Int. Cl. H02K 5/15; H02K 5/16

(52) U.S. Cl. CPC H02K 5/15; H02K 5/161

(57) ABSTRACT

The present invention may provide a motor including a shaft, a rotor coupled to the shaft, a stator disposed to correspond to the rotor, and a housing configured to accommodate the stator, wherein the housing includes a first housing, a second housing, and a first member, the first housing includes a first contact surface, the second housing includes a second contact surface of which at least a partial region is in contact with the first contact surface, a groove portion is positioned between the first contact surface and the second contact surface to be exposed to an outside of the housing, and the first member is disposed in the first housing to cover the groove portion.

### TECHNICAL FIELD

The present invention relates to a motor.

### BACKGROUND ART

In general, a rotor rotates due to an electromagnetic interaction between the rotor and a stator in a motor. In this case, the shaft connected to the rotor is also rotated to generate a rotational driving force.

The rotor and the stator are accommodated in a housing. The housing is a hollow cylindrical member. A bearing plate for accommodating a bearing may be disposed at one end portion of the housing, and a mounting structure connected to an external device may be provided at the other end portion of the housing.

When a die casting method of injection molding through which a molten metal is injected into a mold is used, a housing including both a bearing plate and a mounting structure can be molded. However, the housing manufactured by such a method has a problem of generating cracks.

Meanwhile, the stator may include teeth forming a plurality of slots, and the rotor may include a plurality of magnets facing the teeth. The adjacent teeth are disposed to be spaced apart from each other so as to form slot opens. In this case, while the rotor rotates, a cogging torque may occur due to a difference in permeability between the stator formed of a metal material and air in the slot open, which is an empty space. In addition, a friction torque, which is a direct current component by which a cogging torque waveform is biased in a positive (+) direction and negative (−) direction, may occur.

Since the cogging torque and the friction torque affect steering sensitivity or output power, it is important to reduce the cogging torque and the friction torque so as to secure the performance of the motor.

Meanwhile, a separate fastening member is required to couple the bearing housing and the housing. Accordingly, a process and a component for fastening the bearing housing are required, and thus there is a problem of increasing manufacturing costs.

### DISCLOSURE

### Technical Problem

Accordingly, the present invention is intended to address the above problems and directed to providing a motor in which cracks of a housing are prevented and a cogging torque and a friction torque are reduced.

In addition, the present invention is directed to provide a motor having a simplified installation structure of a bearing housing.

Objectives to be achieved by the present invention are not limited to the above-described objective, and other objectives which are not described above will be clearly understood by those skilled in the art through the following descriptions.

### Technical Solution

One aspect of the present invention provides a motor including a shaft, a rotor coupled to the shaft, a stator disposed to correspond to the rotor, and a housing configured to accommodate the stator, wherein the housing includes a first housing, a second housing, and a first member, the first housing includes a first contact surface, the second housing includes a second contact surface of which at least a partial region is in contact with the first contact surface, a groove portion is positioned between the first contact surface and the second contact surface to be exposed to an outside of the housing, and the first member is disposed in the first housing to cover the groove portion.

The first member may include a third contact surface in contact with the first contact surface, and a partial region of the groove portion may be disposed between the first contact surface and the third contact surface.

The first member may include a fourth contact surface in contact with the second contact surface, and a partial region of the groove portion may be disposed between the second contact surface and the fourth contact surface.

The groove portion may be concavely disposed in an outer surface of the first housing.

The groove portion may be concavely disposed in an inner surface of the second housing.

A partial region of the groove portion may be concavely disposed in the outer surface of the first housing, and the remaining region of the groove portion may be concavely disposed in the inner surface of the second housing.

The first housing may include a first hole passing from an inner side to an outer side of the first housing, the first member may include a second hole, and the first member may be disposed in the first housing so that the first hole and the second hole are aligned.

The first member may include a 1-1 member and a 1-2 member, the second housing may include a third hole passing from an inner side to an outer side of the second housing, the first hole may include a 1-1 hole and a 1-2 hole, the 1-1 hole may be disposed to be aligned with the third hole, the 1-2 hole may be disposed so that the shaft passes through the 1-2 hole, the 1-1 member may be disposed so that the second hole is aligned with the 1-1 hole, and the 1-2 member may be disposed so that the second hole is aligned with the 1-2 hole.

The first housing may include a first sidewall having a first radius and a second sidewall having a second radius smaller than the first radius, and the second housing may include a third sidewall in contact with the first sidewall and a fourth sidewall in contact with the second sidewall.

The first housing may include a first base connecting the first sidewall and the second sidewall, the second housing may include a second base connecting the third sidewall and the fourth sidewall, the groove portion may include a first groove and a second groove, the first groove may be disposed between the first base and the second base, and the second groove may be disposed between the second sidewall and the fourth sidewall.

Another aspect of the present invention provides a motor including a housing, a stator disposed in the housing, a rotor disposed in the stator, and a shaft coupled to the rotor, wherein the housing includes a first region and a second region disposed outside the first region in a radial direction from an axial center of the shaft, the first region is in contact with the stator, the second region is in contact with the first region, and the first region and the second region may be formed of different materials.

Still another aspect of the present invention provides a motor including a housing, a stator disposed in the housing, a rotor disposed in the stator, and a shaft coupled to the rotor, wherein the housing includes a first housing and a second housing, and the first housing is disposed in the groove to be in contact with the stator.

An axial length of the second region may be greater than an axial length of the stator.

A thickness of the first region overlapping the stator in a radial direction may be greater than a thickness of the second region.

The first region may be formed of steel, the second region may be formed of an aluminum alloy, and a ratio between the thickness of the first region and the thickness of the second region may be in the range of 1.0:1.6 to 1.0:2.5.

The first housing may include a plurality of protrusions protruding from an end portion of the housing in an axial direction.

The plurality of the protrusions may be disposed at predetermined intervals along an end of the first housing.

The protrusions may include a first protrusion and a second protrusion, the first protrusion may be disposed at one end of the second housing in the axial direction, and the second protrusion is disposed at the other end portion of the second housing in the axial direction, and a protruding direction of the first protrusion and a protruding direction of the second protrusion may be different from each other.

The second housing may include an open one end portion in the axial direction and the other end portion in which a pocket portion for accommodating a bearing is disposed, the first protrusion may be disposed closer to the one end portion than the second protrusion is, the second protrusion may be disposed closer to the other end portion than the first protrusion is, the first protrusion may be disposed to protrude further outward than an outer circumferential surface of the first housing in the radial direction, and the second protrusion may be disposed to protrude further inward than an inner circumferential surface of the first housing in the radial direction.

The second housing includes an open one end portion in the axial direction and the other end portion in which a pocket portion for accommodating a bearing is disposed, the first protrusion may be disposed closer to the one end portion than the second protrusion is, the second protrusion may be disposed closer to the other end portion than the first protrusion is, the first protrusion may be disposed to protrude from the one end portion of the second housing in the axial direction, and the second protrusion may be disposed to protrude further inward than an inner circumferential surface of the first housing in the radial direction.

### Advantageous Effects

According to an embodiment, an advantageous effect of preventing cracks of a housing are provided by differentiating a method of manufacturing a region of one end portion and the other end portion of the housing and a method of manufacturing a cylindrical region of the housing for accommodating a rotor and a stator.

According to an embodiment, an advantageous effect of reducing a manufacturing process is provided by differentiating a method of manufacturing a region of one end portion and the other end portion of a housing and a method of manufacturing a cylindrical region of the housing for accommodating a rotor and a stator.

According to an embodiment, an advantageous effect of preventing foreign matter or water from being introduced through a gap between a first housing and a second housing is provided.

According to an embodiment, an advantageous effect of reducing both a cogging torque and a friction torque is provided by differentiating a material of a region in contact with a stator from a material of a region constituting a housing structure.

According to an embodiment, since a housing region in contact with a stator core is formed of a steel material, when a stator is press-fitted into a housing, an amount of one-sided interference is significantly reduced, a magnitude of a surface pressure is reduced, and thus an advantageous effect of reducing a friction torque is provided.

According to an embodiment, since a region in contact with a stator core is formed of a steel material serving as a back yoke, an advantageous effect of significantly reducing a cogging torque is provided.

According to an embodiment, since a separate process and a separate component for fastening a bearing housing to a housing can be omitted, manufacturing costs of a motor can be reduced. In addition, since the bearing housing and the housing are easily disassembled and reassembled, a scrap defect rate can be reduced.

### DESCRIPTION OF DRAWINGS

FIG. 1 is a side cross-sectional view illustrating a motor according to an embodiment.

FIG. 2 is an exploded view illustrating the motor illustrated in FIG. 1.

FIG. 3 is a perspective view illustrating a first housing.

FIG. 4 is a side cross-sectional view illustrating the first housing along line A-A of FIG. 3.

FIG. 5 is a view illustrating a second housing.

FIG. 6 is a side cross-sectional view illustrating the second housing along line B-B of FIG. 5.

FIG. 7 is a view illustrating an outer surface of the second housing.

FIG. 8 is a cross-sectional view illustrating a state in which the first housing and the second housing are coupled.

FIG. 9 is a side cross-sectional view illustrating the housing and showing a path along which foreign matter or water is introduced.

FIG. 10 is a view illustrating a state in which a 1-1 member is disposed in a third hole of the second housing.

FIG. 11 is an enlarged view illustrating region K1 of FIG. 8.

FIG. 12 is a view illustrating a state in which a 1-2 member is disposed on the first housing and the second housing.

FIG. 13 is an enlarged view illustrating region K2 of FIG. 8.

FIG. 14 is a view illustrating a modified example of a first groove.

FIG. 15 is a view illustrating a modified example of a second groove.

FIG. 16 is a view illustrating another modified example of a second groove.

FIG. 17 is a side cross-sectional view illustrating a motor according to another embodiment.

FIG. 18 is a view illustrating a first housing and a second housing.

FIG. 19 is a side cross-sectional view illustrating the first housing and the second housing.

FIG. 20 is a perspective view illustrating the first housing.

FIG. 21 is a side cross-sectional view illustrating the first housing along line A-A of FIG. 20.

FIG. 22 is a perspective view illustrating a first housing including a protrusion according to a modified embodiment.

FIG. 23 is a transversal cross-sectional view illustrating the first housing and the second housing.

FIG. 24 is a graph showing amounts of one-sided interference of Comparative Examples and Example.

FIG. 25 is a table showing an amount of one-sided interference and a surface pressure of a motor according to Comparative Example.

FIG. 26 is a table showing an amount of one-sided interference and a surface pressure of a motor according to Example.

FIG. 27 is a table showing a cogging torque of each of Comparative Example and Example.

FIG. 28 is a cross-sectional view illustrating a motor according to one embodiment of the present invention.

FIG. 29 is a plan view illustrating the motor according to one embodiment of the present invention.

FIG. 30 is a cross-sectional view illustrating a housing of the motor according to one embodiment of the present invention.

FIGS. 31 and 32 are enlarged views illustrating region A of FIG. 30.

FIG. 33 is a perspective view illustrating a bearing housing of the motor according to one embodiment of the present invention.

FIG. 34 is a plan view illustrating the bearing housing of the motor according to one embodiment of the present invention.

FIG. 35 is a bottom view illustrating the bearing housing of the motor according to one embodiment of the present invention.

FIG. 36 is an enlarged view illustrating region B of FIG. 35.

FIG. 37 is a side cross-sectional view illustrating the bearing housing of the motor according to one embodiment of the present invention.

FIGS. 38 and 39 are views illustrating a state in which a protrusion is disposed between a first sidewall and a second sidewall of the motor according to one embodiment of the present invention.

FIG. 40 is a partial plan view illustrating the motor according to one embodiment of the present invention.

### MODES OF THE INVENTION

A direction parallel to a longitudinal direction (vertical direction) of a shaft is referred to as an axial direction, a direction perpendicular to the axial direction from the shaft is referred to as a radial direction, and a direction along a circle having a radius in the radial direction from a center, i.e., the shaft, is referred to as a circumferential direction.

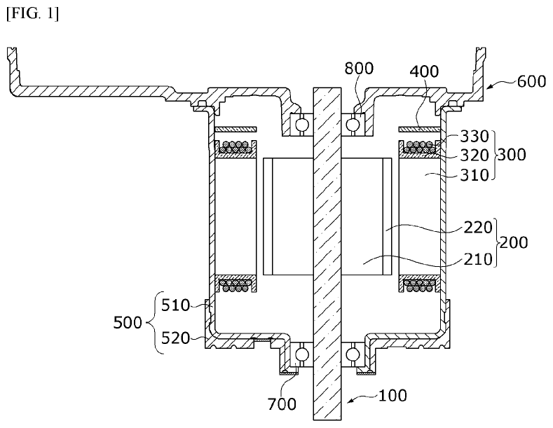

FIG. 1 is a side cross-sectional view illustrating a motor according to an embodiment.

Referring to FIG. 1, the motor according to the embodiment may include a shaft 100, a rotor 200, a stator 300, a busbar 400, a housing 500, and a bearing plate 600. Hereinafter, the term “inward” refers to a direction from the housing 500 toward the shaft 100 which is a center of the motor, and the term “outward” refers to a direction opposite to “inward,” that is, a direction from the shaft 100 toward the housing 500. In addition, a circumferential direction or radial direction is defined with respect to an axial center. In addition, a height direction of the housing 500 may be in a direction parallel to an axial direction.

The shaft 100 may be coupled to the rotor 200. When an electromagnetic interaction occurs between the rotor 200 and the stator 300 by supplying a current, the rotor 200 rotates and the shaft 100 rotates in conjunction with the rotor 200. The shaft 100 may be connected to a steering device of a vehicle to transmit power to the steering device.

The rotor 200 rotates due to an electrical interaction with the stator 300. The rotor 200 may be disposed to correspond to the stator 300 and may be disposed inside the stator 300. The rotor 200 may include a rotor core 210 and a magnet 220.

The stator 300 is disposed outside the rotor 200. The stator 300 may include a stator core 310, an insulator 320, and a coil 330. The insulator 320 is seated on the stator core 310. The coil 330 is mounted on the insulator 320. The coil 330 induces an electrical interaction with the magnet of the rotor 200.

The busbar 400 may be disposed at one side of the stator 300 and connected to the coil 330.

The housing 500 may be disposed outside the stator 300. The housing 500 may be a cylindrical member.

The bearing plate 600 covers an open one side of the housing 500. The bearing plate 600 accommodates a second bearing 700.

A first bearing 700 rotatably supports one side end of the shaft 100.

The second bearing 800 rotatably supports the other end of the shaft.

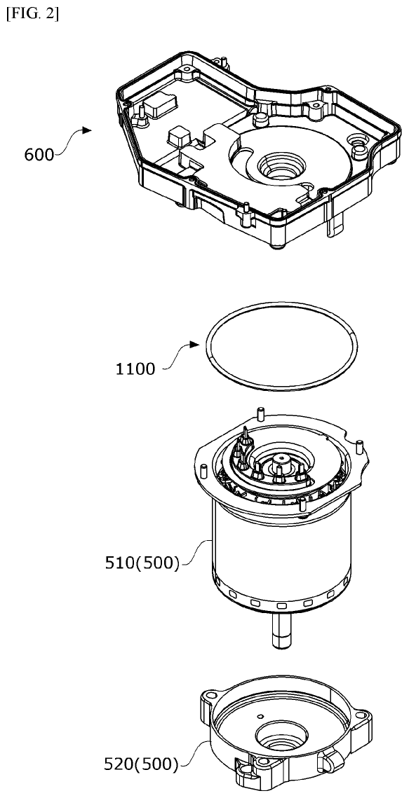

FIG. 2 is an exploded view illustrating the motor illustrated in FIG. 1.

Referring to FIGS. 1 and 2, the housing 500 may be divided into a first housing 510 and a second housing 520. The first housing 510 accommodates the rotor 200 and the stator 300. The first housing 510 may be a cylindrical member of which one side and the other side are open. In addition, the first bearing 700 may be accommodated in the first housing 510.

The second housing 520 is a housing mounted on an external device. The second housing 520 may be coupled to the other end portion of the first housing 510.

In this case, molding methods of the first housing 510 and the second housing 520 are different. The first housing 510 may be molded through a press machining method. The second housing 520 may be molded through a die casting method.

The bearing plate 600 may be disposed on one end portion of the first housing 510. The bearing plate 600 may be formed to include the second bearing 800 through a die casting method.

The first housing 510, which is a cylindrical member having a simple structure, may be molded through the press machining method to fundamentally prevent cracks which may occur in a die casting method, and the second housing 520 and the bearing plate 600, which have relatively complex structures, may be formed through the die casting method to secure manufacturing convenience.

Meanwhile, the first housing 510 and the bearing plate 600 may be fastened using a fastening member, and a sealing member 1100 may be disposed between the first housing 510 and the bearing plate 600. The sealing member 1100 may be an annular member.

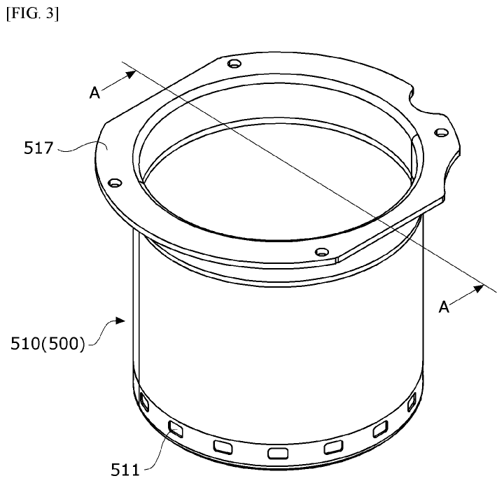

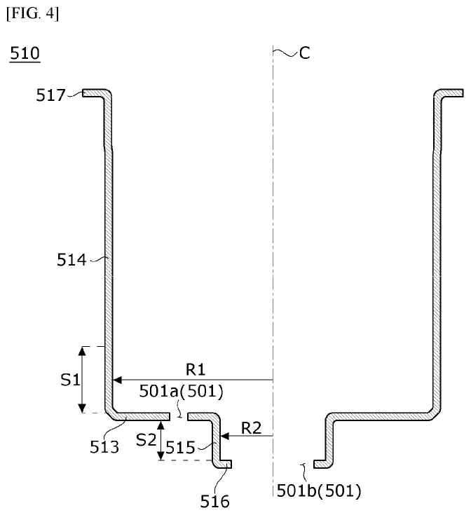

FIG. 3 is a perspective view illustrating the first housing 510, and FIG. 4 is a side cross-sectional view illustrating the first housing 510 along line A-A of FIG. 3.

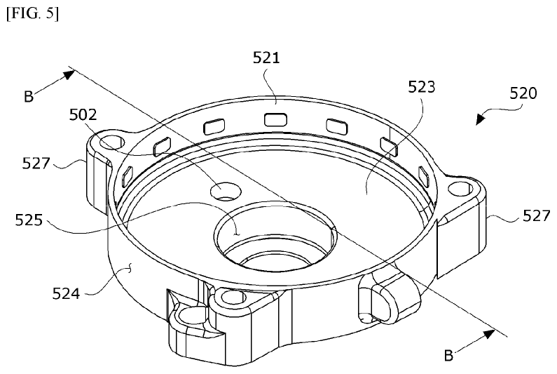

Referring to FIGS. 3 and 4, the first housing 510 may include a plurality of grooves 511. The grooves 511 are disposed on an outer circumferential surface of the first housing 510. The plurality of grooves 511 may be disposed at regular intervals in the circumferential direction of the first housing 510. The grooves 511 may be formed by performing a punching process on the outer circumferential surface of the first housing 510. In particular, the grooves 511 are engaged with first protrusions 521 (see FIG. 5) to fix the second housing 520 so that the second housing 520 is not separated from the first housing 510 in the height direction of the housing 500.

Although each of the grooves 511 having a quadrangular shape is illustrated, the present invention is not limited thereto, and the groove 511 may be formed in any shape such as a circular shape, an angular shape, or an oval shape.

The first housing 510 may include a first base 513, a first sidewall 514, a second sidewall 515, and a fifth sidewall 516. The first sidewall 514 is disposed to protrude from the first base 513 toward one side, and the second sidewall 515 is disposed to protrude from the first base 513 toward the other side. An inner surface of the first sidewall 514 may be in contact with the stator 300.

The first sidewall 514 may have a first radius R1 from an axial center C of the first housing 510, and the second sidewall 515 may have a second radius R2. The second radius R2 is smaller than the first radius R1.

The first sidewall 514 may include first coupling means in an outer surface. The first coupling means may be the grooves 511 disposed in the outer surface of the first sidewall 514. The grooves 511 may be disposed at an edge of the first sidewall 514 close to the first base 513.

An inner surface of the second sidewall 515 may be in contact with an outer wheel of the first bearing 700. The second sidewall 515 serves to accommodate the first bearing 700.

The fifth sidewall 516 is disposed to be bent inward from the second sidewall 515.

A shape of the first housing 510 may be implemented through the press machining method.

Meanwhile, the first housing 510 may include a flange 517. The flange 517 is a portion to be coupled to the bearing plate 600. The flange 517 may be disposed to be bent outward from one end of the first sidewall 514. The sealing member 1100 (see FIG. 1) is disposed in contact with the flange 517.

In a region in which the first housing 510 and the second housing 520 are in contact with each other, the first housing 510 may include a first region S1 and a second region S2. The first region S1 has the first radius R1 from the axial center C. The second region S2 has the second radius R2, which is different from the first radius R1, from the axial center C. The second radius R2 may be smaller than the first radius R1.

The first housing 510 may include first holes 501 which pass through an inner side and an outer side. The first holes 501 may include a 1-1 hole 501a and a 1-2 hole 501b.

The first base 513 may include the 1-1 hole 501a. The 1-1 hole 501a passes through the inner side and the outer side of the first housing 510. The 1-1 hole 501a is a hole for ventilation of an inner space of the first housing 510. The 1-2 hole 501b may be disposed in the fifth sidewall 516. The 1-2 hole 501b is a hole through which the shaft 100 passes.

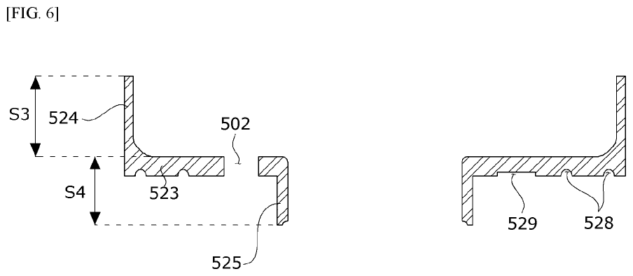

FIG. 5 is a view illustrating the second housing 520, and FIG. 6 is a side cross-sectional view illustrating the second housing 520 along line B-B of FIG. 5.

Referring to FIGS. 5 and 6, the second housing 520 may include a plurality of first protrusions 521. The first protrusions 521 are disposed on an inner circumferential surface of the second housing 520. The plurality of first protrusions 521 may be disposed at predetermined intervals in the circumferential direction of the second housing 520. The first protrusions 521 may be formed in a die casting process of the second housing 520. Accordingly, the number, positions, and shapes of the first protrusions 521 may correspond to the grooves 511 disposed in the first housing 510.

The second housing 520 may include a second base 523, a third sidewall 524, and a fourth sidewall 525. The third sidewall 524 is disposed to protrude from the second base 523 toward one side. The fourth sidewall 525 is disposed to protrude from the second base 523 toward the other side. Coupling portions 527 may be disposed to protrude from an outer circumferential surface of the third sidewall 524. The coupling portions 527 are engaged with the external device.

The second housing 520 may include a third region S3 and a fourth region S4. The third region S3 is in contact with the first region S1. The fourth region S4 is in contact with the second region S2.

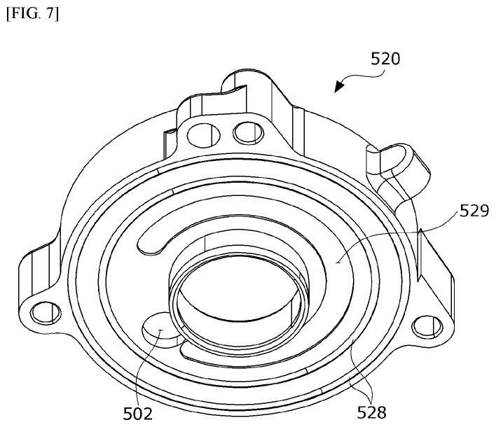

FIG. 7 is a view illustrating an outer surface of the second housing 520.

Referring to FIGS. 6 and 7, the outer surface of the second housing 520 may include a third hole 502, a third groove 528, and a fourth groove 529.

A membrane for ventilation may be disposed in the third hole 502.

The third groove 528 may be an annular groove disposed along a circumference of the fourth sidewall 525. The third groove 528 may be concavely formed in the outer surface of the second housing 520 to accommodate a sealing oil or O-ring. The outer surface of the second housing 520 is a region to which an external mounting part is coupled. Foreign matter or water can be blocked from being introduced through a gap between the external mounting part and the outer surface of the housing 520 using the sealing oil or O-ring accommodated in the third groove 528.

The fourth groove 529 may be a ring-shaped groove disposed along the circumference of the fourth sidewall 525. A protruding portion of the external mounting part may be seated in the fourth groove 529.

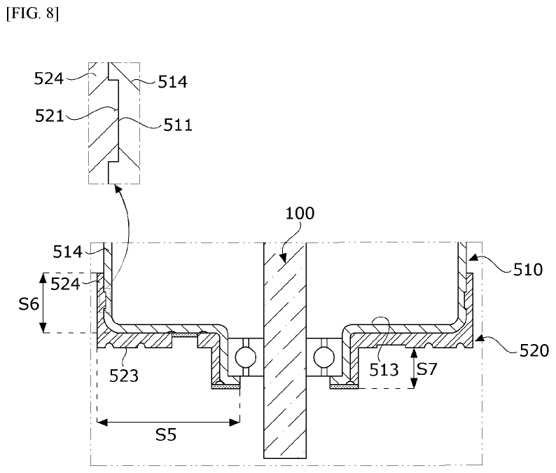

FIG. 8 is a cross-sectional view illustrating a state in which the first housing 510 and the second housing 520 are coupled.

Referring to FIG. 8, the second housing 520 is formed to cover one end portion of the first housing 510 through the die casting method. An inner surface of the second housing 520 is in contact with a part of an outer surface of the first housing 510.

A fifth region S5 is a region in which the first housing 510 and the second housing 520 overlap in the axial direction. A sixth region S6 and a seventh region S7 are regions in which the first housing 510 and the second housing 520 overlap in the direction perpendicular to the axial direction.

In the fifth region S5, a part of the first housing 510 and a part of the second housing 520 may be disposed to overlap in the height direction of the housing 500 through a die casting process. For example, in a process of molding the second housing 520, the first housing 510 and the second housing 520 may be coupled and the first protrusions 521 may be disposed in the grooves 511 at the same time to significantly increase a coupling force of the first housing 510 and the second housing 520 in the axial direction.

The outer surface of the first sidewall 514 of the first housing 510 and an inner surface of the third wall 524 of the second housing 520 are in contact with each other. An outer surface of the first base 513 of the first housing 510 and an inner surface of the second base 523 of the second housing 520 are in contact with each other. In addition, an outer surface of the second sidewall 515 of the first housing 510 and an inner surface of the fourth sidewall 525 of the second housing 520 are in contact with each other.

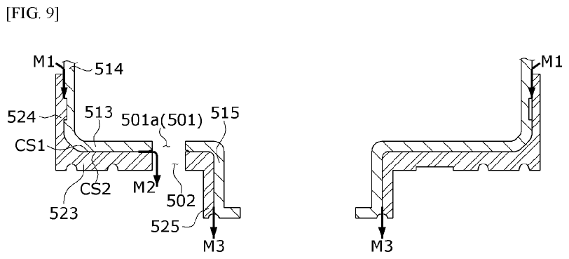

FIG. 9 is a side cross-sectional view illustrating the housing 500 and showing a path along which foreign matter or water is introduced.

Referring to FIG. 9, water (or foreign matter) may be introduced through a gap between the first sidewall 514 and the second sidewall 515 as indicated by an arrow M1 of FIG. 9. The introduced water may flow between the first base 513 and the second base 523 and may flow into the external mounting part through the third hole 502 as indicated by an arrow M2 of FIG. 9. In addition, the introduced water may flow between the second sidewall 515 and the fourth sidewall 525 and flow into the external mounting part as indicated by an arrow M 3 of FIG. 9. A substrate on which a control element is disposed may be mounted on the external mounting part, and the introduced water may cause a fatal problem in controlling the motor.

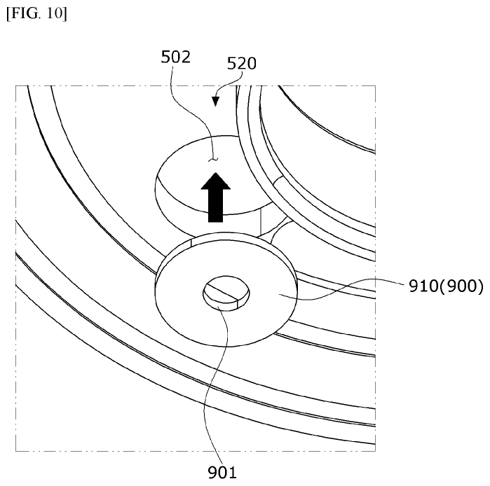

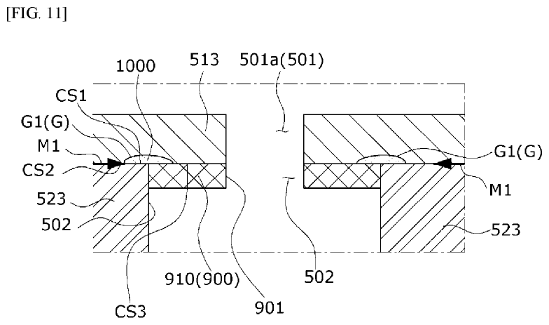

FIG. 10 is a view illustrating a state in which a 1-1 member 910 is disposed in a third hole 502 of the second housing 520, and FIG. 11 is an enlarged view illustrating region K1 of FIG. 8.

Referring to FIGS. 9 to 11, a first member 900 is disposed on the housing 500 to cover a groove portion G. The first member 900 may have a disc shape and may be an annular metal member in which a second hole 901 is disposed in a center. The first member 900 is a member for fixedly covering and pressing the exposed groove portion G in a state in which a sealing member fills the groove portion G.

The first member 900 may be divided into a 1-1 member 910 and a 1-2 member 920. The 1-1 member 910 may be disposed in the third hole 502, and the 1-2 member 920 may be disposed under the fifth sidewall 515 of the first housing 510. The 1-1 member 910 may be disposed so that the second hole 901 is aligned with a first hole 501a.

Water introduced into a gap between the first sidewall 514 and the second sidewall 515 is prevented from flowing into the external mounting part using the sealing member 1000 filling the groove portion G. The groove portion G may include a first groove G1 and a second groove G2. The first groove G1 is disposed in the third hole 502. The water introduced into the gap between the first sidewall 514 and the second sidewall 515 is blocked using the sealing member 1000 filling the first groove G1 so that the water is not discharged through the third hole 502 as indicated by the arrow M2 of FIG. 9.

The first groove G1 is positioned between a first contact surface CS1 of the first housing 510 and a second contact surface CS2 of the second housing 520. For example, the first groove G1 may be concavely formed in an outer surface of the first housing 510. The second contact surface CS2 is a surface in contact with the first contact surface CS1. The first groove G1 is positioned to be partially exposed through the third hole 502. This is to fill the first groove G1 with the sealing member 1000 in a state in which the first housing 510 and the second housing 520 are coupled.

The first member 900 includes a third contact surface CS3 in contact with the first contact surface CS1. A partial region of the first groove G1 may be disposed between the first contact surface CS1 and the third contact surface CS3. Accordingly, the first groove G1 may be disposed at a boundary between the first base 513 and the 1-1 member 910. Since the first groove G1 is positioned on a path along which water introduced into the gap between the first sidewall 514 and the second sidewall 515 is discharged to the third hole 502, the water can be effectively prevented from flowing into the external mounting part.

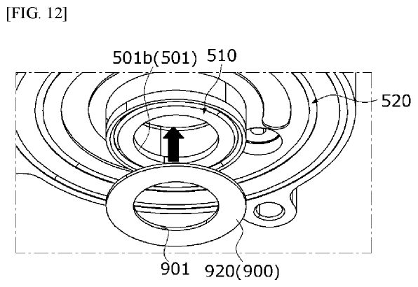

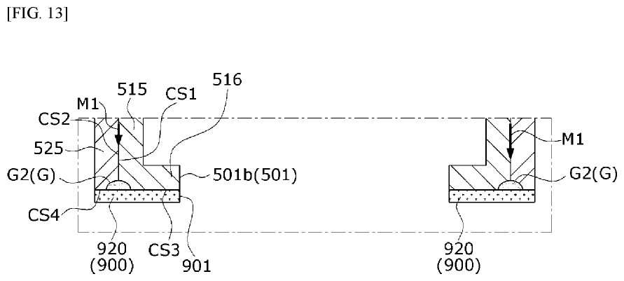

FIG. 12 is a view illustrating a state in which the 1-2 member is disposed on the first housing 510 and the second housing 520, and FIG. 13 is an enlarged view illustrating region K2 of FIG. 8.

Referring to FIGS. 9, 12, and 13, the second groove G2 may be disposed between the second sidewall 515 and the fourth sidewall 525 and disposed across an end of the second sidewall 515 and an end of the fourth sidewall 525. A part of the second groove G2 may be disposed in the second sidewall 515 and concavely formed in the outer surface of the second sidewall 515. The rest of the second groove G2 may be disposed in the fourth sidewall 525 and concavely formed in the inner surface of the fourth sidewall 525. The second groove G2 is exposed to the outside in a state in which the first housing 510 and the second housing 520 are coupled.

The 1-2 member 920 may be disposed under the fifth sidewall 515 of the first housing 510 and under the fourth sidewall 525 of the second housing 520. The 1-2 member 920 is disposed so that the second hole 901 is aligned with the 1-2 hole 501b.

The 1-2 member 920 may include the third contact surface CS3 in contact with the first contact surface CS1 of the first housing 510 and a fourth contact surface CS4 in contact with the second contact surface CS2 of the second housing 520.

A partial region of the second groove G2 may be disposed between the first contact surface CS1 and the third contact surface CS3. In addition, the remaining region of the second groove G2 may be disposed between the second contact surface CS2 and the fourth contact surface CS4.

Accordingly, the second groove G2 may be disposed at a boundary between the second sidewall 515 and the fourth sidewall 525. Since the second groove G2 is positioned on a path along which water introduced into the gap between the second sidewall 515 and the fourth sidewall 525 is discharged to an end of the housing, the water can be effectively prevented from flowing into the external mounting part.

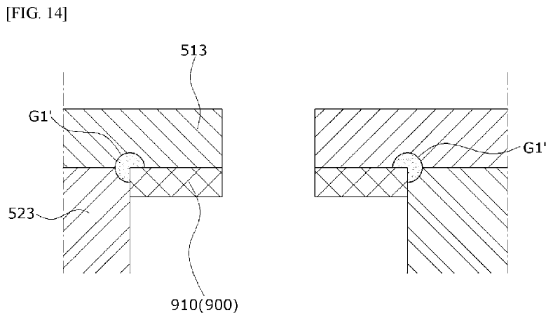

FIG. 14 is a view illustrating a modified example of a first groove G1′.

Referring to FIG. 14, a partial region of the first groove G1′ according to the modified embodiment may be concavely formed in an outer surface of a first base 513, and the remaining region of the first groove G1′ may be formed in a second base 523.

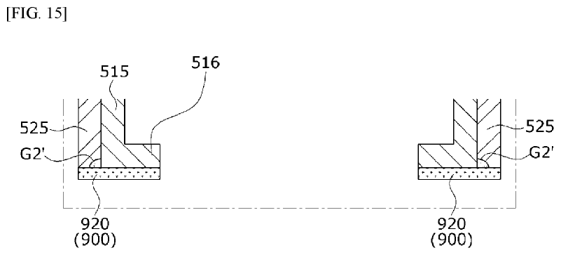

FIG. 15 is a view illustrating a modified example of a second groove G2′.

Referring to FIG. 15, the second groove G2′ according to the modified embodiment may not be disposed in a second sidewall 515 but may be disposed in only an inner surface of a fourth sidewall 525.

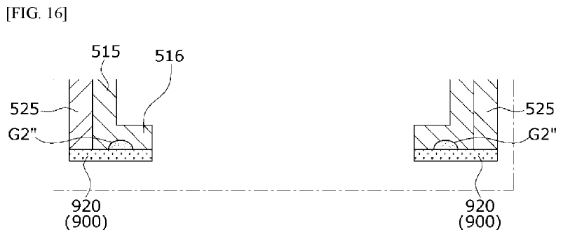

FIG. 16 is a view illustrating another modified example of a second groove G2″.

Referring to FIG. 16, the second groove G2″ according to another modified embodiment may not be disposed in a fourth sidewall 525 but may be disposed across a second sidewall 515 and a fifth sidewall 516.

In the above embodiments, an example of an inner rotor type motor has been described, but the present invention is not limited thereto. The present invention is also applicable to an outer rotor type motor. In the embodiments, examples of the motor including the busbar or bearing plate have been described, but the present invention is not limited thereto and is applicable to a motor without a busbar or bearing plate.

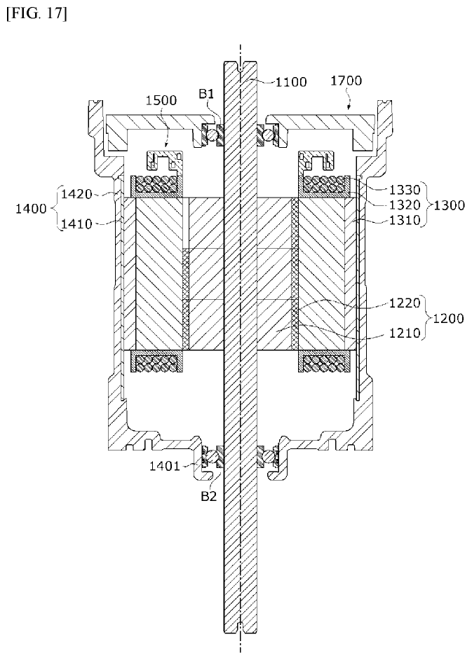

FIG. 17 is a side cross-sectional view illustrating a motor according to an embodiment.

Referring to FIG. 17, the motor according to the embodiment may include a shaft 1100, a rotor 1200, a stator 1300, a housing 1400, a busbar 1500, and a bearing housing 1600. Hereinafter, the term “inward” refers to a direction from the housing 1400 toward the shaft 1100 which is a center of the motor, and the term “outward” refers to a direction opposite to “inward,” that is, a direction from the shaft 1100 toward the housing 1400.

The shaft 1100 may be coupled to the rotor 1200. When an electromagnetic interaction occurs between the rotor 1200 and the stator 1300 by supplying a current, the rotor 1200 rotates, and the shaft 1100 rotates in conjunction with the rotor 1200.

The rotor 1200 rotates due to an electrical interaction with the stator 1300. The rotor 1200 may be disposed to correspond to the stator 1300 and may be disposed inside the stator 1300. The rotor 1200 may include a rotor core 210 and a magnet 220.

The stator 1300 may be disposed outside the rotor 1200. The stator 1300 may include a stator core 1310, an insulator 1320, and a coil 1330. The insulator 1320 is seated on the stator core 1310. The coil 1330 is mounted on the insulator 1320. The coil 1330 induces an electrical interaction with the magnet 1220 of the rotor 1200.

The housing 1400 may be disposed outside the stator 1300. The housing 1400 may be a cylindrical member.

The busbar 1500 may be disposed at one side of the stator 1300 and connected to coil 1330.

The bearing housing 1600 covers an open one side of the housing 1400. The bearing housing 1600 accommodates a bearing B1.

The bearing B1 may support one end portion of the shaft 1100, and another bearing B2 may support the other end portion of the shaft 1100. The bearing B2 may be accommodated in a pocket portion 1401 of the housing 1400.

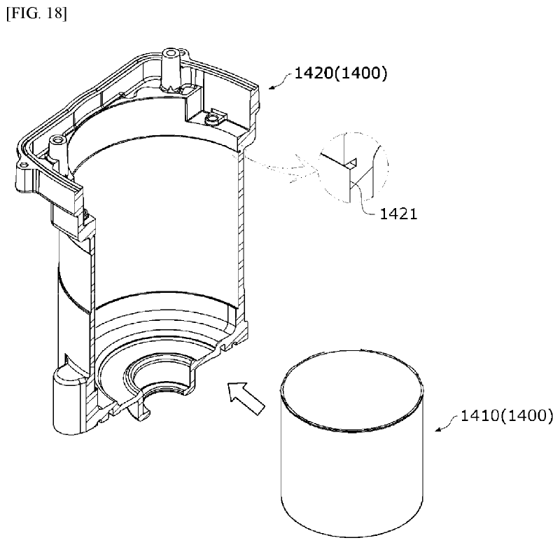

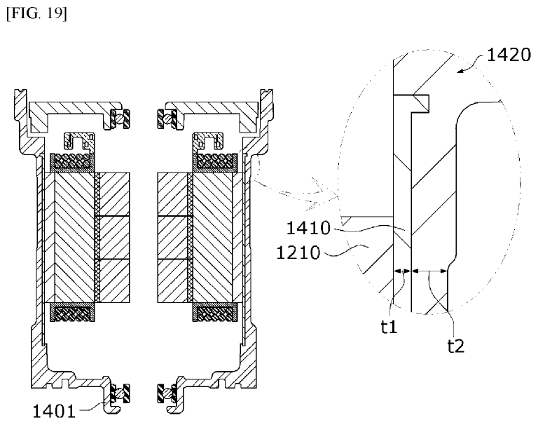

FIG. 18 is a view illustrating a first housing 1410 and a second housing 1420, and FIG. 19 is a side cross-sectional view illustrating the first housing 1410 and the second housing 1420.

Referring to FIGS. 17 to 19, the housing 1400 may be divided into a first region and a second region of which materials are different. The first region may be disposed relatively inward in a radial direction from an axial center of the shaft 1100, and the second region may be disposed outside the first region. An inner circumferential surface of the first region is in contact with the stator core 1310, and an inner circumferential surface of the second region is in contact with an outer circumferential surface of the first region. An axial length of the second region may be greater than an axial length of the first region so that the entire first region may be disposed to be included in the second region. Hereinafter, the first region corresponds to the first housing 1410, and the second region corresponds to the second housing 1420.

The first housing 1410 may be formed of an aluminum alloy (for example, ALDC12), and the second housing 1420 may be formed of steel (for example, 50PN250). The second housing 1420 may be in contact with an outer circumferential surface of the stator core 1310 to serve as a back yoke of the stator. When a housing formed of aluminum is used, a cogging torque is generally increased. When a housing formed of a steel material is used to reduce a cogging torque, the cogging torque can be reduced, but a friction torque may increase as a surface pressure increases because a range of an amount of one-sided friction, that is, a press fitting tolerance, is wide and a value thereof is large. In the housing 1400 of the motor according to the embodiment, it is intended to reduce the friction torque while reducing the cogging torque by combining the first housing 1410 formed of the steel material and the second housing 1420 formed of the aluminum alloy.

The second housing 1420 is a cylindrical member and has a relatively simple shape, however, since a complex structure, such as, a mounting structure of a control unit and a fastening structure, is disposed in the first housing 1410, the second housing 1420 may be insert-injection molded to integrally form the first housing 1410 and the second housing 1420.

Structurally, a groove 421 may be disposed in an inner circumferential surface of the second housing 1420, and the first housing 1410 may be disposed in the groove 1421. The first housing 1410 may be coupled to the second housing 1420 so that an inner circumferential surface of the first housing 1410 is exposed. The inner circumferential surface of the first housing 1410 and the inner circumferential surface of the second housing 1420 may be disposed consecutively.

Referring to FIG. 19, in a section overlapping the stator core 1310 in the radial direction, a minimum thickness t1 of the first housing 1410 may be smaller than a minimum thickness t2 of the second housing 1420. In this case, a thickness is defined based on a region in which the stator core 1310 is press-fitted into the housing 1400. According to a ratio between a thickness of the first housing 1410 and a thickness of the second housing 1420, a cogging torque and a friction torque may vary.

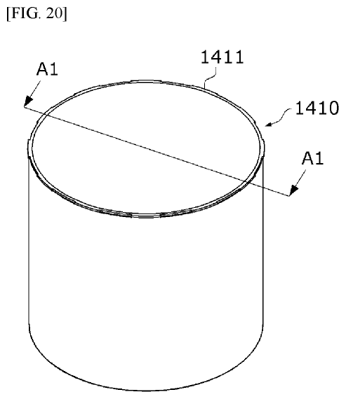

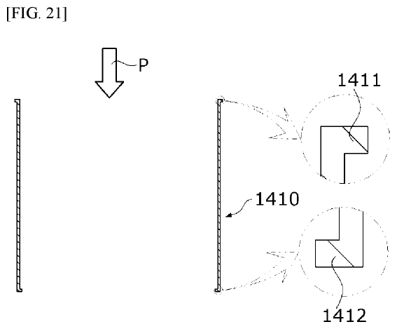

FIG. 20 is a perspective view illustrating the first housing 1410, and FIG. 21 is a side cross-sectional view illustrating the first housing 1410 along line A-A of FIG. 20.

Referring to FIGS. 20 and 21, the first housing 1410 may include a plurality of protrusions 1411 and 1412. The protrusions 1411 and 1412 may be divided into first protrusions 1411 and second protrusions 1412. The first protrusions 1411 may be disposed at one end of the first housing 1410 in an axial direction. The second protrusions 1412 may be disposed at the other end of the second housing 1420 in the axial direction. A protruding direction of the first protrusions 1411 and a protruding direction of the second protrusions 1412 may be different. For example, the first protrusions 1411 may be disposed to be bent outward from one end of the first housing 1410. Conversely, the second protrusions 1412 may be disposed to be bent inward from the other end of the second housing 1420.

Meanwhile, the second housing 1420 may include one end portion that is open in the axial direction and the other end portion in which the pocket portion 1401 for accommodating the bearing B2 is disposed.

On the basis of the axial direction, the stator core 1310 enters one end of the first housing 1410 at which the first protrusions 1411 are positioned. Accordingly, the first protrusions 1411 may be bent to protrude outward from one end of the first housing 1410 so as not to interfere with the stator core 1310 which enters the inside of the first housing 1410. Accordingly, the first protrusions 1411 may be disposed to protrude further outward than an outer circumferential surface of the first housing 1410 in the radial direction. In addition, since the second protrusions 1412 are not interfered with the stator core 1310 which enters the inside of the first housing 1410, the second protrusions 1412 may be bent to protrude inward from the other end of the first housing 1410. The second protrusions 1412 may be disposed to protrude further inward than the inner circumferential surface of the first housing 1410 in the radial direction.

The first protrusions 1411 are disposed closer to open one end portion of the second housing 1420 than the second protrusions 1412 are, and the second protrusions 1412 are disposed closer to the other end portion of the second housing 1420 in which the pocket portion 1401 is disposed than the first protrusions 1411 are.

The first protrusions 1411 and the second protrusions 1412 may be disposed at regular intervals in a circumferential direction of the second housing 1420.

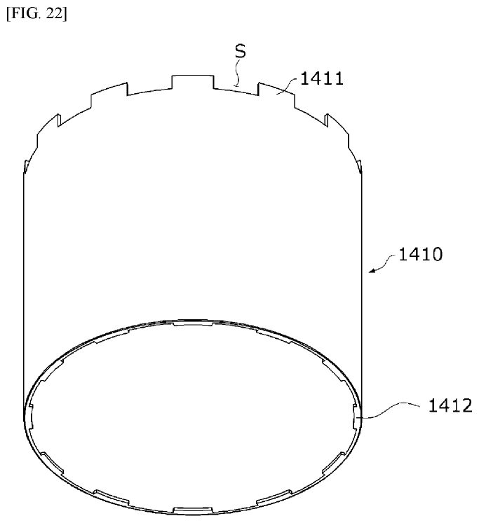

FIG. 22 is a perspective view illustrating a first housing 1410 including a protrusion according to a modified embodiment.

Referring to FIG. 22, in protrusions 1411 and 1412 according to the modified embodiment, first protrusions 1411 may be disposed to protrude from one end of a first housing 1410 in an axial direction so as not to interfere with a stator core 1310 which enters the inside of the first housing 1410. Spaces S are disposed between the adjacent first protrusions 1411, and a part of a second housing 1420 is positioned in the spaces S so that the first housing 1410 and the second housing 1420 are mutually restricted in a circumferential direction.

In addition, the second protrusions 1412 may be disposed to protrude further inward than an inner circumferential surface of the second housing 1420 in a radial direction.

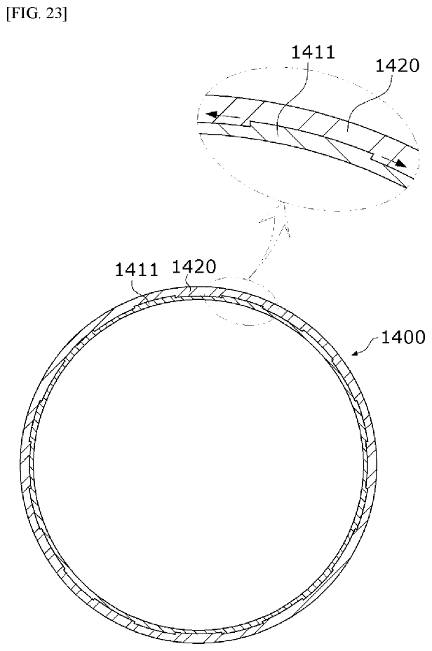

FIG. 23 is a transversal cross-sectional view illustrating the first housing 1410 and the second housing 1420.

Referring to FIG. 23, the first protrusions 1411 serve to prevent slip occurring between the first housing 1410 and the second housing 1420. Although only the first protrusions 1411 are illustrated in FIG. 23, the second protrusions 1412 also serve the same function as the first protrusions 1411.

Since the first housing 1410 is formed in a cylindrical shape, when there are no first protrusions 1411 and second protrusions 1412, the first housing 1410 slides on the second housing 1420 in the circumferential direction, a fatal problem that the stator core 1310 rotates may occur. The first protrusions 1411 and the second protrusions 1412 may be restricted by the second housing 1420 in the circumferential direction to prevent the first housing 1410 from sliding on the second housing 1420.

In addition, since the first protrusions 1411 or the second protrusions 1412 are disposed to protrude inward or outward from the first housing 1410, there is an advantage that the first housing 1410 is fixed so as not to slide on the second housing 1420 even in the axial direction.

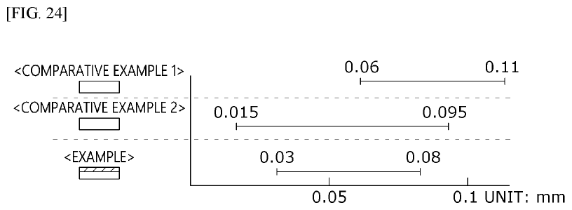

FIG. 24 is a graph showing amounts of one-sided interference of Comparative Examples and Example. In FIG. 8, Comparative Example 1 is a motor including a housing formed of only an aluminum alloy (for example, ALDC12) and having a thickness of 3.5 mm. Comparative Example 2 is a motor including a housing formed of only steel and having a thickness of 1.6 mm. Example is a motor including a first housing 1410 formed of a steel material and having a thickness of 1.0 mm and a second housing 1420 having a thickness of 2.5 mm.

A hot press fitting method may be applied as a method of fixing a stator 1300 to the first housing 1410 and the second housing 1420 of the motor of Example. In the case of the hot press fitting method, an overlap region of an inner diameter of the first housing 1410 and an outer diameter of a stator core 1310, that is, an amount of one-sided interference, is set in a room temperature state before heating to secure a fixing force to fix the stator core 1310 during cooling after the heating.

As illustrated in FIG. 24, in the case of Comparative Example 1, a range of an amount of one-sided interference is 0.06 mm to 0.11 mm which is not wide, but since a required amount of one-sided interference is large, there is a risk of increasing a surface pressure applied to a stator core 1310 in a hot press fitting process.

In the case of Comparative Example 2, since a range of an amount of one-sided interference is 0.015 mm to 0.0095, which is wide, and a required amount of one-sided interference is relatively large, there is a risk of increasing a surface pressure applied to a stator core 1310.

However, in the case of Embodiment, a range of an amount of one-sided interference is 0.03 mm to 0.08, which is not relatively wide, and since a required amount of one-sided interference is not large, a surface pressure applied to the stator core 1310 can be significantly reduced.

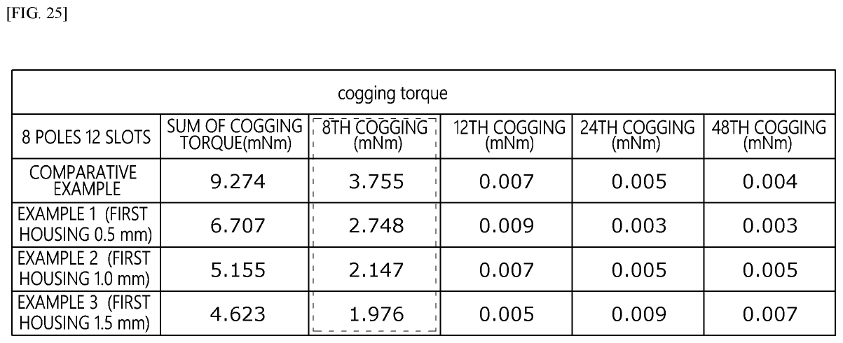

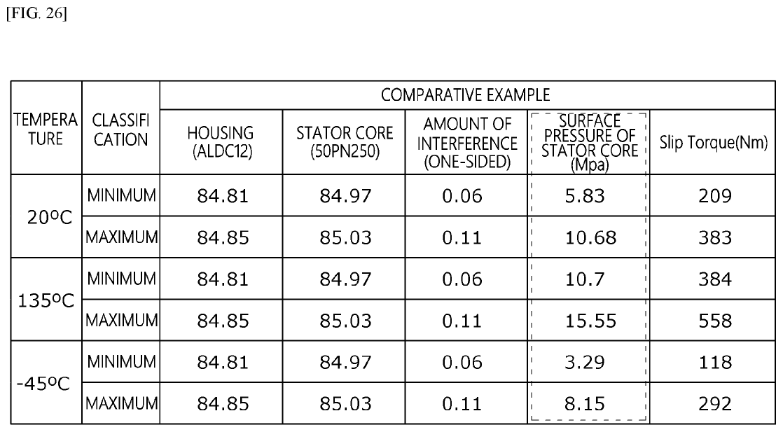

FIG. 25 is a table showing an amount of one-sided interference and a surface pressure of a motor according to Comparative Example, and FIG. 26 is a table showing an amount of one-sided interference and a surface pressure of a motor according to Example.

Referring to FIGS. 24 and 25, Comparative Example is a motor including a housing formed of only an aluminum alloy (for example, ALDC12). Comparative Example is the motor corresponding to Comparative Example 1 of FIG. 24. The table shown in FIG. 25 shows a surface pressure of Comparative Example measured at room temperature of 20°, a heating temperature of 135°, and a cooling temperature of −45 ° at a minimum value of 0.06 mm and a maximum value of 0.11 mm in the range of 0. mm to 0.11 mm of an amount of one-sided interference.

Referring to FIGS. 24 and 26, Example is a motor including a housing having a first housing 1410 formed of a steel (SPCD) material and a second housing 1420 formed of an aluminum alloy (ALDC12). The table shown in FIG. 26 shows a surface pressure of Example measured at room temperature of 20°, a heating temperature of 135°, and a cooling temperature of −45° at a minimum value of 0.03 mm and a maximum value of 0.08 mm in the range of 0.03 mm to 0.08 mm of an amount of one-sided interference.

In Comparative Example and Example, it can be seen that the surface pressure applied to a stator core 1310 of Embodiment is significantly reduced compared to the surface pressure applied thereto under all the temperature conditions. Since the surface pressure applied to the stator core 1310 is low by reducing a press fitting tolerance, a friction torque can also be significantly reduced.

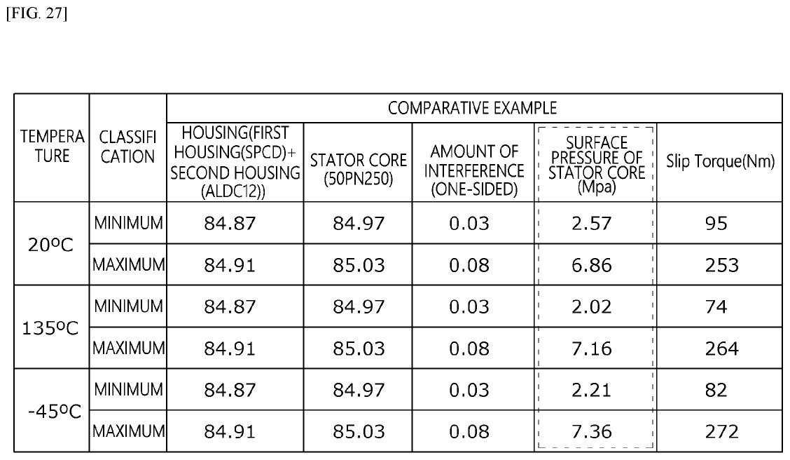

FIG. 27 is a table showing a cogging torque of each of Comparative Example and Example.

In FIG. 27, Comparative Example is a motor including a housing formed of only an aluminum alloy. Example 1 is a motor including a housing 1400 having a first housing 1410 formed of a steel material and a second housing 1420 formed of an aluminum alloy, and a minimum thickness of the first housing 1410 is 0.5 mm. Example 2 is a motor including a housing having a first housing 1410 formed of a steel material and a second housing 1420 formed of an aluminum alloy, and a minimum thickness of the first housing 1410 is 1.0 mm. Example 3 is a motor including a housing having a first housing 1410 formed of a steel material and a second housing 1420 formed of an aluminum alloy, and a minimum thickness of the first housing 1410 is 1.5 mm.

In the table of FIG. 27, an eighth component of a cogging torque is caused by a stator core 1310, a twelfth component of the cogging torque is caused by a rotor core, and twelfth, 24^{th}, and 48^{th} components thereof are caused by the stator core 1310 and the rotor core. Mostly, the eighth component greatly affects the cogging torque, and when compared to Comparative Example, in a section in which a minimum thickness of the first housing 1410 is 1.0 mm to 1.5 mm, it can be seen that the cogging torque is significantly reduced at not only the eighth component but also the components of entire degrees. It can be seen that the cogging torque is significantly reduced in a range in which a ratio between a minimum thickness of the first housing 1410 and a minimum thickness of the second housing is 1.0:1.6 to 1.0:2.5. For example, when the minimum thickness of the second housing 1420 is 2.5 mm, the minimum thickness of the first housing 1410 may be in the range of 1.0 mm to 1.5 mm.

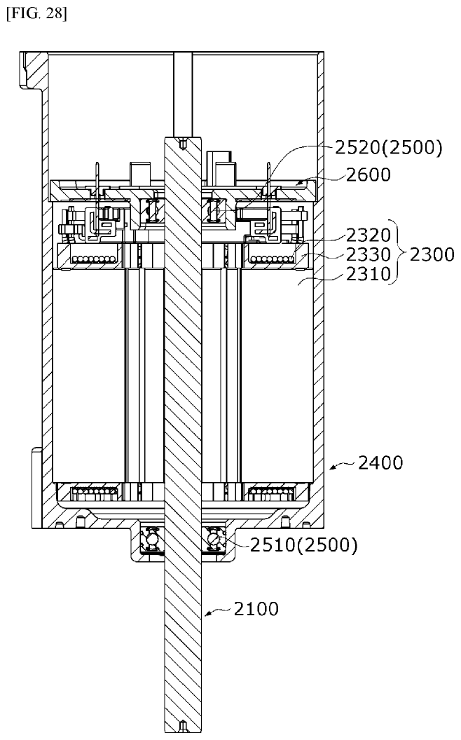

FIG. 28 is a cross-sectional view illustrating a motor according to one embodiment of the present invention.

Referring to FIG. 28, the motor includes a shaft 2100, a rotor 2200, a stator 2300, a housing 2400, bearings 2500, and a bearing housing 2600.

Hereinafter, the term “inward” refers to a direction from the housing 2400 toward the shaft 2100 which is a center of the motor, and the term “outward” refers to a direction opposite to “inward,” that is, a direction from the shaft 2100 toward the housing 2400.

The shaft 2100 may be coupled to the rotor 2200. When an electromagnetic interaction occurs between the rotor 2200 and the stator 2300 by suppling a current, the rotor 2200 rotates, and the shaft 2100 rotates in conjunction with the rotor 2200. The shaft 2100 may be connected to a steering device of a vehicle to transmit power to the steering device.

The rotor 2200 rotates due to an electrical interaction with the stator 2300. The rotor 2200 may be disposed inside the stator 2300. The rotor 2200 may include a rotor core and a rotor magnet disposed on the rotor core.

The stator 2300 is disposed outside the rotor 2200. The stator 2300 may include a stator core 2310, a coil 2320, and an insulator 2330 mounted on the stator core 2310. The coil 2320 may be wound around the insulator 2330. The insulator 2330 is disposed between the coil 2320 and the stator core 2310. The coil 2320 induces an electrical interaction with the rotor magnet.

The housing 2400 may be disposed outside the stator 2300. The housing 2400 may be a cylindrical member having an open one side. A shape or a material of the housing 2400 may be variously changed, and a metal material which can endure well at high temperatures may be selected for the housing 2400.

The bearings 2500 rotatably support the shaft 2100. The bearings 2500 may be coupled to both end portions of the shaft 2100. The bearings 2500 may include a first bearing 2510 and a second bearing 2520. The first bearing 2510 and the second bearing 2520 may be spaced apart from each other in an axial direction.

The bearing housing 2600 supports the bearing. The bearing housing 2600 is coupled to the housing 2400.

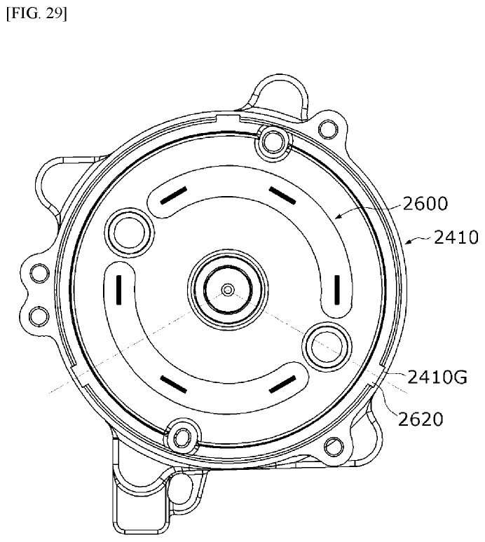

FIG. 29 is a plan view illustrating the motor according to one embodiment of the present invention.

Referring to FIG. 29, the housing 2400 includes a body 2410 coupled to the bearing housing 2600. The stator 2300 may be disposed in the body 2410. The body 2410 may have a cylindrical shape. In addition, the bearing housing 2600 is disposed at one side of the stator 2300. A diameter of an inner circumferential surface of the body 2410 may be greater than a diameter of an outer circumferential surface of the bearing housing 2600. In addition, at least one groove 2410G may be formed in the inner circumferential surface of the body 2410. A protrusion of the bearing housing 2600, which will be described below, is disposed in the groove 2410G. The groove 2410G may be provided as a plurality of grooves 2410G. The plurality of grooves 2410G may be spaced apart from each other in a circumferential direction. The number of the grooves 2410G may be three. The three grooves 2410G may be disposed at intervals of 120 degrees with respect to an axial center. The grooves 2410G may extend to an end portion of the body 2410.

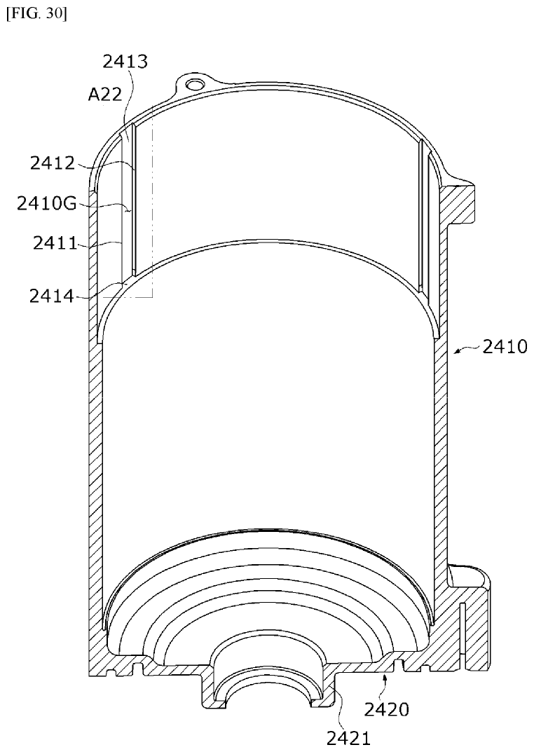

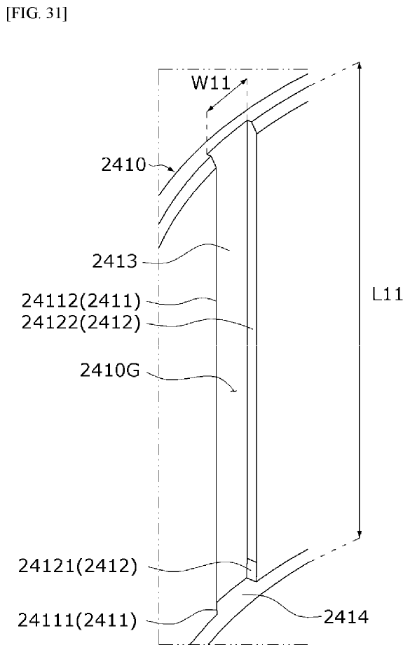

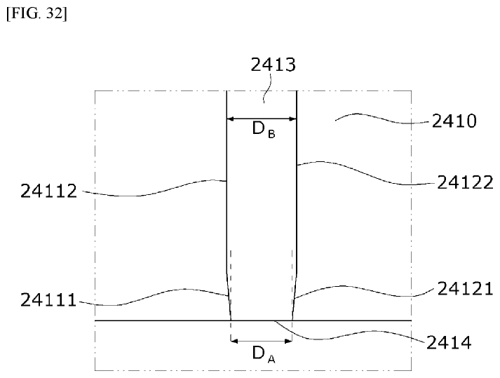

FIG. 30 is a cross-sectional view illustrating the housing of the motor according to one embodiment of the present invention, and FIGS. 31 and 32 are enlarged views illustrating region A of FIG. 30.

Referring to FIG. 30, the body 2410 may include first sidewalls 2411 and second sidewalls 2412. The first sidewalls 2411 and the second sidewalls 2412 are disposed on the inner circumferential surface of the body 2410. The first sidewalls 2411 and the second sidewalls 2412 may be spaced apart from each other in the circumferential direction with the grooves 2410G interposed therebetween. In addition, the body 2410 may include inner surfaces 2413 connecting the first sidewalls 2411 and the second sidewalls 2412. The first sidewalls 2411 and the second sidewalls 2412 are formed in pairs. In this case, three pairs of first sidewalls 2411 and second sidewalls 2412 may be disposed on the inner circumferential surface of the body 2410.

The body 2410 may include a step 2414. The step 2414 is disposed on the inner circumferential surface of the body 2410. The step 2414 is disposed to be spaced a predetermined distance from the end portion of the body 2410. In this case, the first sidewalls 2411, the second sidewalls 2412, and the inner surfaces 2413 may be disposed between the step 2414 and the end portion of the body 2410. The step 2414 may be disposed perpendicular to the first sidewalls 2411, the second sidewalls 2412, and the inner surfaces 2413. A distance from an axial center to one of the inner surfaces 2413 may be greater than a distance from the axial center to the step 2414. An inner diameter of the step 2414 may be smaller than a diameter of the outer circumferential surface of the bearing housing 2600. Accordingly, the bearing housing 2600 may be seated on the step 2414. An edge of the bearing housing 2600 is in contact with the step 2414.

The housing 2400 includes a bottom surface 2420. The bottom surface 2420 may extend inward from the body 2410. The bottom surface 2420 supports one of the bearings 2500. In addition, the bottom surface 2420 may include a first bearing pocket portion 421. The first bearing 2510 may be disposed in the first bearing pocket portion 421. A hole through which the shaft 2100 passes is formed in the bottom surface 2420.

Referring to FIGS. 31 and 32, the first sidewalls 2411 and the second sidewalls 2412 may extend in the axial direction. An axial length of each of the first sidewalls 2411 and an axial length of each of the second sidewalls 2412 may be an axial length L11 of the groove 2410G. In addition, the first sidewall 2411 and the second sidewall 2412 may be spaced apart from each other in the circumferential direction. A distance between the first sidewall 2411 and the second sidewall 2412 in the circumferential direction may be a circumferential width W11 of the groove 2410G. In this case, the axial length L11 of the groove 2410G may be greater than the circumferential width W11.

The first sidewall 2411 may include a 1A region 24111 and a 1B region 24112. The 1A region 24111 and the 1B region 24112 may be disposed in the axial direction. The 1A region 24111 may be connected to the step 2414. In addition, the 1B region 24112 may extend from the 1A region 24111. The 1B region 24112 may extend to the end portion of the body 2410. The 1A region 24111 may overlap a protrusion 2620 of the bearing housing 2600, which will be described below, in the circumferential direction. In this case, at least a part of the 1A region 24111 may be in contact with one surface of the protrusion 2620.

The second sidewall 2412 may include a 2A region 24121 and a 2B region 24122. The 2A region 24121 and the 2B region 24122 may be disposed in the axial direction. The 2A region 24121 may face the 1A region 24111. In addition, the 2B region 24122 may face the 1B region 24112. The 2A region 24121 may overlap the protrusion 2620 of the bearing housing 2600, which will be described below, in the circumferential direction. In addition, at least a part of the 2A region 24121 may be in contact with another surface of the protrusion 2620.

The 1A region 24111 and the 2A region 24121 may be obliquely disposed in the axial direction. A distance between the 1A region 24111 and the 2A region 24121 may gradually decrease toward the end portion. In addition, a minimum distance DA between the 1A region 24111 and the 2A region 24121 may be smaller than a circumferential width of the protrusion 2620. In addition, a maximum distance between the 1A region 24111 and the 2A region 24121 may be the same as a distance DB between the 1B region 24112 and the 2B region 24122. In addition, the distance DB between the 1B region 24112 and the 2B region 24122 may be greater than the circumferential width of the protrusion 2620. Accordingly, the protrusion 2620 disposed in the groove 2410G may slide between the 1B region 24112 and the 2B region 24122 in the axial direction.

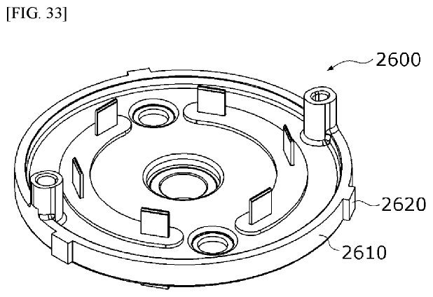

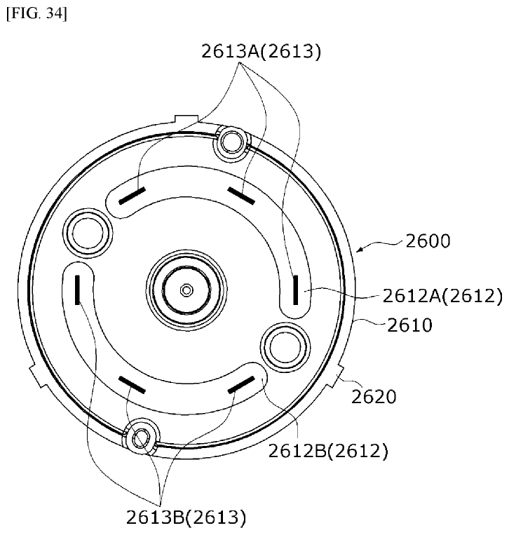

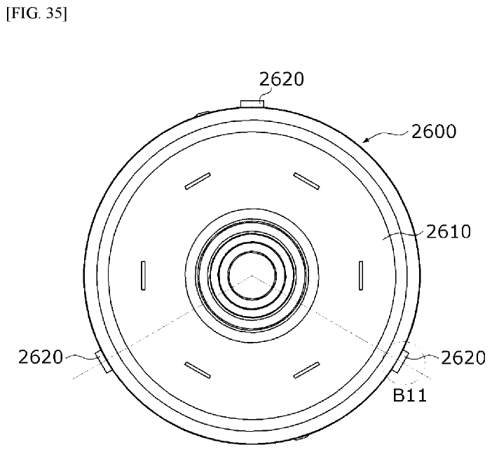

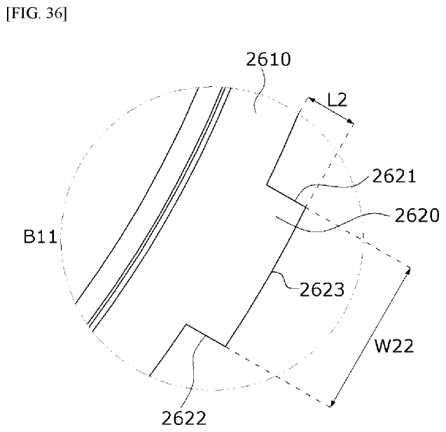

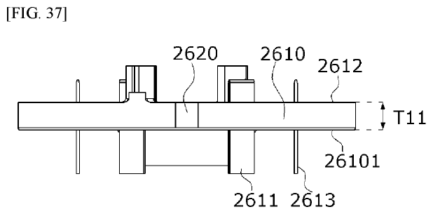

FIG. 33 is a perspective view illustrating the bearing housing of the motor according to one embodiment of the present invention, and FIG. 34 is a plan view illustrating the bearing housing included in the motor according to one embodiment of the present invention. FIG. 35 is an enlarged view illustrating region B of FIG. 34, FIG. 36 is a bottom view illustrating the bearing housing included in the motor according to one embodiment of the present invention, and FIG. 37 is a side cross-sectional view illustrating the bearing housing included in the motor according to one embodiment of the present invention.

Referring to FIGS. 33 to 37, the bearing housing 2600 may include a plate 2610 and at least one protrusion 2620.

The plate 2610 may have a plate shape. The plate 2610 is disposed inside the housing 2400. An outer circumferential surface of the plate 2610 may face the inner circumferential surface of the body 2410. In addition, the plate 2610 is disposed to be spaced apart from the bottom surface 2420 in the axial direction. In this case, the stator 2300 may be disposed between the plate 2610 and the bottom surface 2420. The plate 2610 supports the bearing 2500. The plate 2610 may include a second bearing pocket portion 2611. The second bearing 2520 is disposed in the second bearing pocket portion 2611. In addition, a hole through which the shaft 2100 passes is formed in the plate 2610.

The bearing housing 2600 may include a support 2612 and a power terminal 2613. The support 2612 may be disposed on the plate 2610. In addition, the power terminal 2613 may be disposed on the support 2612. The power terminal 2613 is provided as a plurality of power terminals 2613. In this case, the support 2612 may connect the plurality of power terminals 2613 in an insulated state. The support 2612 may be a mold member. An end portion of the power terminal 2613 may be exposed from the support 2612. The end portion of the exposed power terminal 2613 may be electrically connected to the stator 2300. In this case, the support 2612 and the power terminal 2613 may be disposed on the plate 2610 through an insert-injection molding.

The support 2612 may include a first support 2612A and a second support 2612B. The first support 2612A and the second support 2612B may be disposed in the circumferential direction. In addition, the power terminals 2613 may include a first power terminals 2613A and a second power terminal 2613B. A power unit (not shown) may apply three-phase power through the first power terminal 2613A. In addition, the power unit (not shown) may separately apply three-phase power through the second power terminal 2613B. Three first power terminals 2613A may be disposed on the first support 2612A. In addition, three second power terminals 2613B may be disposed on the second support 2612B.

The first power terminal 2613A and the second power terminal 2613B may apply power to electrically separated coils which are electrically separated. The coils of the stator 2300 may include a first coil and a second coil which are electrically separated. The first coil and the second coil may be wound in a dual winding manner. The first power terminal 2613A may be electrically connected to the first coil, and the second power terminal 2613B may be electrically connected to the second coil.

At least one protrusion 2620 may be disposed on the outer circumferential surface of the plate 2610. The protrusion 2620 may be integrally formed with the plate 2610. Three protrusions 2620 may be formed. The three protrusions 2620 may be spaced at equal intervals in the circumferential direction. The three protrusions 2620 may be disposed at intervals of 120 degrees with respect to an axial center. The protrusions 2620 may be disposed in the grooves formed in an inner circumferential surface of housing 2400.

The protrusion 2620 may include a first surface 2621, a second surface 2622, and a third surface 2623. The first surface 2621, the second surface 2622, and the third surface 2623 may be disposed in the groove 2410G. The first surface 2621 and the second surface 2622 may be disposed in the circumferential direction. A distance between the first surface 2621 and the second surface 2622 may be a circumferential width W22 of the protrusion 2620. In this case, the circumferential width W22 of the protrusion 2620 may be greater than a radial length L22 of the protrusion 2620.

The plate 2610 may include a lower surface 6101 and an upper surface 6102. The lower surface 6101 may be disposed to face the stator 2300. In addition, the upper surface 6102 may be an opposite surface of the lower surface 6101. In addition, the second bearing pocket portion 2611 may be disposed in the lower surface 6101. In addition, a distance between the lower surface 6101 and the upper surface 6102 may be an axial thickness T11 of the plate 2610. In this case, the axial thickness T11 of the plate 2610 may be greater than or equal to an axial thickness of the protrusion 2620. The power terminal 2613 may protrude from the lower surface 6101 and the upper surface 6102. In this case, an axial thickness T of the plate 2610 may be smaller than an axial length of the power terminal 2613.

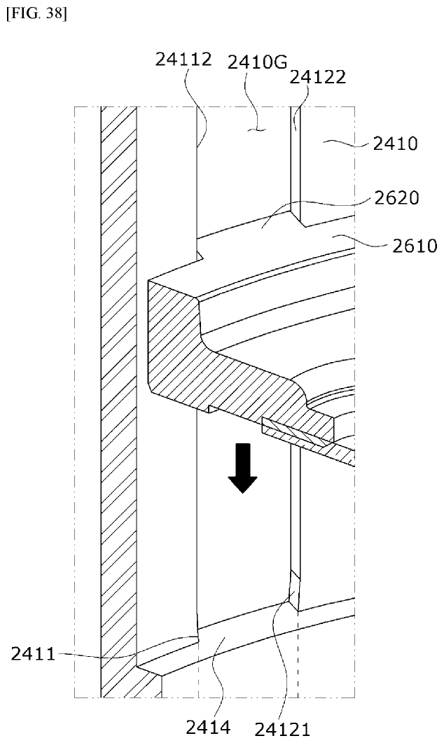

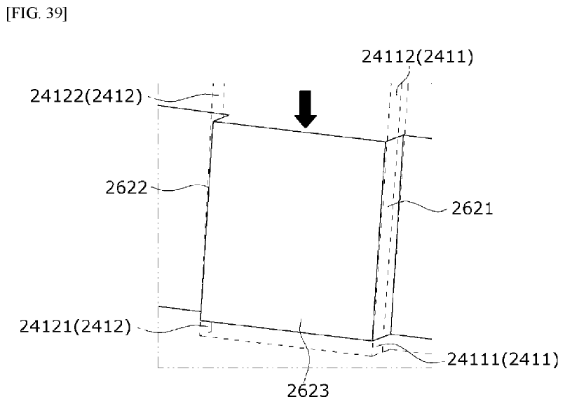

FIGS. 38 and 39 are views illustrating a state in which the protrusion is disposed between the first sidewall and the second sidewall of the motor according to one embodiment of the present invention.

Referring to FIGS. 38 and 39, the protrusion 2620 is disposed in the groove 2410G. In addition, the protrusion 2620 may slide along the first sidewall 2411 and the second sidewall 2412. The protrusion 2620 may slide from the end portion of the body 2410 toward the step 2414. In this case, the protrusion 2620 may pass between the 1B region 24112 and the 2B region 24122 and may be disposed between the 1A region 24111 and the 2A region 24121.

A minimum distance between the 1A region 24111 and the 2A region 24121 may be smaller than the circumferential width of the protrusion 2620. Accordingly, the protrusion 2620 may be press-fitted between the 1A region 24111 and the 2A region 24121. In this case, two surfaces of the protrusion 2620 may come into contact with the 1A region 24111 and the 2A region 24121. In this case, the two surfaces of the protrusion 2620 may be interfered with the 1A region 24111 and the 2A region 24121.

As described above, in the motor according to one embodiment of the present invention, the bearing housing and the housing can be coupled while the protrusion formed on the bearing housing is press-fitted into the groove of an inner surface of the housing. Accordingly, a separate process and a separate component for fastening the bearing housing to the housing can be omitted, and thus manufacturing costs of the motor can be reduced. In addition, since the bearing housing and the housing according to the present invention have structures which can be disassembled and reassembled, a scrap defect rate can be reduced.

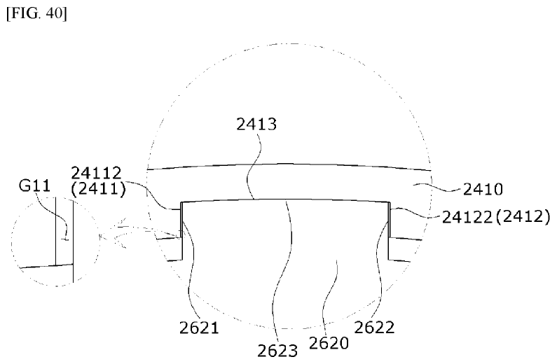

FIG. 40 is a partial plan view illustrating the motor according to one embodiment of the present invention.

The protrusion 2620 is fixed to the body 2410. Referring to FIG. 40, the first surface 2621 of the protrusion 2620 may face the first sidewall 2411. In addition, the second surface 2622 may face the second sidewall 2412. In this case, movement of the protrusion 2620 may be restricted in the circumferential direction as the first surface 2621 comes into contact with the 1A region of the first sidewall 2411 and the second surface 2622 comes into contact with the 2A region of the second sidewall 2412. In addition, the third surface 2623 may face the inner surface 2413. In addition, movement of the protrusion 2620 in a radial direction may be restricted as the third surface 2623 comes into contact with the inner surface 2413. As described above, the movement of the protrusion 2620 in the circumferential direction and the radial direction may be prevented by an inner wall of the body 2410. Accordingly, the bearing housing can be fixedly installed in the housing without a separate fastening member.

The first surface 2621 and the 1B region 24112 of the first sidewall 2411 may be spaced apart from each other. In addition, the second surface 2622 and the 2B region 24122 of the second sidewall 2412 may be spaced apart from each other. Accordingly, a gap G may be formed between the first surface 2621 and the first sidewall 2411 or between the second surface 2622 and the second sidewall 2412. In addition, an adhesive member (not shown) may be disposed in the gap G. In addition, the adhesive member may be further disposed on an outer circumferential surface of the plate. In addition, the adhesive member (not shown) may be further disposed between the third surface 2623 and the inner surface 2413. A silicone hardener may be illustrated as an example of the adhesive member (not shown), but the present invention is not limited thereto. In the present invention the housing and the bearing housing may be bonded to improve a fixing force of the bearing housing.

In addition, the present invention can be used in various devices such as vehicles or home appliances.

1-10. (canceled)

11. A motor comprising:
a shaft;
a rotor coupled to the shaft;
a stator disposed to correspond to the rotor; and
a housing configured to accommodate the stator,
wherein the housing includes a first housing, a second housing, and a first member,
wherein the first housing includes a first contact surface,
wherein the second housing includes a second contact surface of which at least a partial region is in contact with the first contact surface,
wherein a groove portion is positioned between the first contact surface and the second contact surface to be exposed to an outside of the housing,
wherein the first member is disposed in the first housing to cover the groove portion, and
wherein the first housing includes a first sidewall having a first radius and a second sidewall having a second radius smaller than the first radius, and the second housing include a third sidewall in contact with the first sidewall and a fourth sidewall in contact with the second sidewall.

12. The motor of claim 11, wherein the first member includes a third contact surface in contact with the first contact surface, and
wherein a partial region of the groove portion is disposed between the first contact surface and the third contact surface.

13. The motor of claim 11, wherein the first member includes a fourth contact surface in contact with the second contact surface, and
wherein a partial region of the groove portion is disposed between the second contact surface and the fourth contact surface.

14. The motor of claim 11, wherein a partial region of the groove portion is concavely disposed in an outer surface of the first housing, and
wherein the remaining region of the groove portion is concavely disposed in an inner surface of the second housing.

15. A motor comprising:
a housing;
a stator disposed in the housing;
a rotor disposed in the stator; and
a shaft coupled to the rotor,
wherein the housing includes a first region and a second region disposed outside the first region in a radial direction from an axial center of the shaft,
wherein the first region is in contact with the stator,
wherein the second region is in contact with the first region,
wherein the first region and the second region are formed of different materials, and
wherein a thickness of the first region overlapping the stator in a radial direction is greater than a thickness of the second region.

16. The motor of claim 15, wherein an axial length of the second region is greater than an axial length of the stator.

17. A motor comprising:
a housing;
a stator disposed in the housing;
a rotor disposed in the stator; and
a shaft coupled to the rotor,
wherein the housing includes a first housing and a second housing,
wherein the second housing includes a groove in an inner surface,
wherein the first housing is disposed in the groove and is in contact with the stator, and
wherein the plurality of the protrusions is disposed at predetermined intervals along an end of the first housing.

18. A motor comprising:
a shaft;
a rotor coupled to the shaft;
a stator disposed to correspond to the rotor;
a housing configured to accommodate the stator;
a bearing which supports the shaft; and
a bearing housing which supports the bearing,
wherein the housing includes a body coupled to the bearing housing,
wherein the bearing housing includes a protrusion protruding toward the body,
wherein the protrusion includes a first surface and a second surface disposed in a circumferential direction,
wherein the body includes a first sidewall of which at least a part is in contact with the first surface and a second sidewall of which at least of a part is in contact with the second surface,
wherein the first sidewall includes a 1A region and the 1A region overlaps a protrusion of the bearing housing,
wherein the second sidewall includes a 2A region and the 2A region overlaps a protrusion of the bearing housing, and
wherein a distance between the 1A region and the 2A region is gradually decrease toward the end portion.

19. The motor of claim 18, wherein a groove is disposed between the first sidewall and the second sidewall, and
wherein the protrusion is disposed in the groove.

20. The motor of claim 18, wherein a gap is formed between the first surface and the first sidewall or between the second surface and the second sidewall, and
wherein an adhesive member is disposed in the gap.
